(19) United States
(12) Patent Application Publication
(10) Pub. No.: US 2017/0107464 A1
(43) Pub. Date: Apr. 20, 2017

(54) BEER-LIKE BEVERAGE

(71) Applicant: ASAHI BREWERIES, LTD., Tokyo (JP)

(72) Inventors: Shoko KANAYAMA, Moriya-shi (JP); Kohei MIZUTANI, Moriya-shi (JP); Toru KISHIMOTO, Moriya-shi (JP); Shigekuni NOBA, Moriya-shi (JP)

(73) Assignee: ASAHI BREWERIES, LTD., Tokyo (JP)

(21) Appl. No.: 15/318,083

(22) PCT Filed: May 15, 2015
(86) PCT No.: PCT/JP2015/064005

§ 371 Date: Dec. 12, 2016

(30) Foreign Application Priority Data
Jul. 11, 2014 (JP) 2014-143433

(51) Int. Cl. C12C 5/02; C12G 3/04

(52) U.S. Cl. CPC C12C 5/02; C12G 3/04

(57) ABSTRACT

The problem of the present invention is to provide a beer-like drink having enhanced beer-like taste thickness, body feeling and complex taste. The means for solving the problem is a beer-like drink obtained by including a fatty acid having 8 to 14 carbon atoms.

### TECHNICAL FIELD

The present invention relates to a beer-like drink, and particularly to a beer-like drink having improved taste quality.

### BACKGROUND ART

Supported by a recent trend of price reduction, a lot of low-molt beer-like drinks, which employ malt in low percentage, or do not employ malt, are commercially available. Non-fermented beer taste drinks, for which fermentation has not been conducted during the production process, rise in demand because they do not need specific fermentation apparatuses to be able to produce inexpensively. The low-malt beer-like drinks or non-fermented beer-like drinks tend to loose authentic beer flavor or rich feeling.

On the other hand, customers are increasingly interested in sugar amount, calorie amount and particularly purine body amount contained in the beer-like drinks owing to their health consciousness. Among these, the purine body is metabolized at the liver to be uric acid. When the uric acid value in blood rises beyond a certain value, hyperuricemia is caused. Further, when the uric acid is crystallized to accumulate at joint, gout is caused. It has been increased a request of customers to a fermented malt drink which is low in sugar amount and low in calorie amount, and retains good taste that the conventional beer is having, as well as a beer-like drink which is low, in purine body content.

Grain feeling and complex taste that beer-like drinks are having, are originated from the malt, which is a raw material. The wort or the malt extract contains much purine body. In order to keep the purine content low, usage of the wort or the malt extract also need to be suppressed. The beer taste alcohol drinks having low purine body content lack grain feeling and complex taste which customers are expecting with beer taste alcohol drinks.

Beer-like alcohol drinks in which the content of sugar or purine body has been reduced, could have been subjected to a method of sugar and purine body removal such as activated carbon treatment during their production process. The method removes up to the components originally necessary for retaining beer-like taste, and the balance of taste is lost.

On the other hand, beer-like non-alcohol drinks are generally produced without employing an alcohol fermentation process. When compared to beer, they lack beer-like rich feeling and drink fulfilment.

When the taste quality is focused, beer-like drinks aiming at price reduction, and functional beer-like drinks such as low calorie, low alcohol, low sugar, zero sugar, low purine body, zero purine body or non-alcohol, feel watery and undependable in taste. More specifically, they lack taste thickness, body feeling and complex taste. The beer-like drinks do not fully meet the requests of customers in an aspect of preference.

Patent document 1 discloses a process for producing a drink containing flavor components derived from hop, wherein the process comprises a step of including lower fatty acids or esters thereof. The process for producing a drink of patent document 1 includes lower fatty acids or esters thereof in a drink containing flavor components derived from hop to enhance the flavor of monoterpene alcohol.

The monoterpene alcohol is however a flavor component. Even if the flavor of monoterpene alcohol is enhanced, taste thickness, body feeling and complex taste of the beer-like drink will not be sufficiently enhanced.

### BACKGROUND ART DOCUMENTS

Patent Document 1 JP 2012-34659 A

### SUMMARY OF THE INVENTION

### Problems to be Solved by the Invention

The present invention solves the above-mentioned conventional problems, and an object thereof is to provide a beer-like drink having enhanced beer-like taste thickness, body feeling and complex taste.

### Means for Solving the Problems

The present invention provides a beer-like drink obtained by including a fatty acid having 8 to 14 carbon atoms.

In one embodiment, the fatty acid having 8 to 14 carbon atoms comprises at least one selected from the group consisting of octanoic acid, decanoic acid, 9-decenoic acid, nonanoic acid and tetradecanoic acid.

In one embodiment, kind and concentration of the fatty acid included in the beer-like drink is at least one selected from the group consisting of the following i) to v):

i) 0.2 to 20 ppm of octanoic acid;

ii) 0.02 to 20 ppm of decanoic acid;

iii) 0.01 to 20 ppm of 9-decenoic acid;

iv) 0.05 to 5 ppm of nonanoic acid; and

v) 0.05 to 5 ppm of tetradecanoic acid.

The present invention provides a beer-like drink obtained by including a fatty acid having 10 to 14 carbon atoms.

In one embodiment, kind and concentration of the fatty acid included in the beer-like drink is at least one selected from the group consisting of the following i) to iii):

i) 0.02 to 20 ppm of decanoic acid;

ii) 0.01 to 20 ppm of 9-decenoic acid; and

iii) 0.05 to 5 ppm of tetradecanoic acid.

In one embodiment, the beer-like drink is a non-fermented beer-like drink.

In one embodiment, the beer-like drink has an extract content of not more than 2.5% by weight.

In one embodiment, the beer-like drink has a carbohydrate concentration of less than 0.5 g/100 ml.

In one embodiment, the beer-like drink has a purine body concentration of not more than 1 mg/100 ml.

In one embodiment, the beer-like drink has an energy amount of less than 5 kcal/100 ml.

The present invention provides a process for producing a beer-like drink comprising a step of including a fatty acid having 8 to 14 carbon atoms.

### Effect of the Invention

The present invention provides a beer-like drink having enhanced beer-like taste thickness, body feeling and complex taste.

### DESCRIPTION OF EMBODIMENTS

It turns out that the taste quality of a beer-like drink is improved when a medium chain fatty acid or a long chain fatty acid having comparatively small number of carbon atoms is included in the beer-like drink. The fatty acid is, for example, a fatty acid having 8 to 14 carbon atoms. The fatty acid is, for example, a fatty acid having 9 to 14 carbon atoms. The fatty acid is, for example, a fatty acid having 10 to 14 carbon atoms. The medium chain fatty acid or the long chain fatty acid having comparatively small number of carbon atoms may be employed alone or in combination of plural kinds.

Examples of the fatty acid having 8 to 14 carbon atoms include, for example, octanoic acid, ethylhexanoic acid, methylheptanoic acid, octenoic acid, oxooctanoic acid, nonanoic acid, methyloctanoic acid, nonenoic acid, trimethylhexanoic acid, ethylheptanoic acid, decanoic acid, decenoic acid, citronellic acid, ethyloctanoic acid, ethyloctenoic acid, geranic acid, methylnonanoic acid, oxodecanoic acid, undecanoic acid, undecenoic acid, dodecanoic acid, dodecenoic acid, oxododecanoic acid, tridecanoic acid, tridecenoic acid, tetradecanoic acid and tetradecenoic acid. A preferred combination when a plurality of the fatty acids having 8 to 14 carbon atoms are employed includes octanoic acid, decanoic acid, 9-decenoic acid, nonanoic acid or tetradecanoic acid. A preferred combination when a plurality of the fatty acids having 9 to 14 carbon atoms are employed includes 9-decenoic acid, nonanoic acid and tetradecanoic acid. A preferred combination when a plurality of the fatty acids having 10 to 14 carbon atoms are employed includes 9-decenoic acid and tetradecanoic acid. A preferred combination when a plurality of the fatty acids having 8 to carbon atoms are employed includes octanoic acid and decanoic acid.

Kind and usage of the fatty acid are suitably determined taking an addition effect into consideration. Preferred fatty acids and addition amounts are those such that the contents in the drink become as follows.

| | | More | Further |
|---|---|---|---|
| | Preferred | preferred | preferred |
| Fatty acid | amount (ppm) | amount (ppm) | amount (ppm) |
| octanoic acid | 0.2-20 | 0.5-10 | 1-4 |
| decanoic acid | 0.02-20 | 0.05-5 | 0.1-1 |
| 9-decenoic | 0.01-20 | 0.025-10 | 0.05-5 |
| acid | | | |
| nonanoic acid | 0.05-5 | 0.1-3 | 0.3-0.6 |
| tetradecanoic | 0.05-5 | 0.1-3 | 0.3-0.6 |
| acid | | | |

When content of the fatty acid having 8 to 14 carbon atoms is less than the range, it becomes insufficient the effect of enhancing beer-like taste thickness, body feeling and complex taste. When it is more than the range, excessive rich feeling or flavor is provided, and there is concern that balance of the total flavor is lost. The term “improvement” means to modify so as to suit a major consumer's taste, specifically means to enhance beer-like flavor, grain feeling and rich feeling peculiar to beer, taste thickness, body feeling, and complex taste.

The beer-like drink means every drink having beer-like flavor irrespective of having been fermented or not. The beer-like drink includes, for example, the above described beer-like alcohol drink, beer, sparkling liqueur, miscellaneous liqueur, liqueurs, spirits, low-alcohol drink, and non-alcohol drink, which have beer-like flavor.

Among these, a preferred beer-like drink as a target for improving taste quality is a beer-like drink which has low malt employing percentage in starch raw materials, or a beer-like drink which employs no malt as starch raw materials. This is because such a beer-like drink is weak in flavor or richness feeling peculiar to beer. Even a beer-like alcohol drink produced through fermentation steps, this is also the case when the malt employing percentage is low, or when no malt is employed. For example, many beer-like drinks produced with employing grains as raw materials which include not more than 25% by weight (w/w), particularly not more than 20% by weight, or not more than 15% by weight of malt, are poor in flavor or richness feeling peculiar to beer.

What we call functional beer such as beer-like low-carbohydrate alcohol drink, beer-like low-purine body alcohol drink, beer-like low-calorie alcohol drink and beer-like low-alcohol drink, is also a preferred beer-like drink as a target for improving taste quality. This is because the flavor substances required for realizing appropriate taste quality are often removed during the steps of reducing carbohydrate, reducing calorie, reducing purine body or reducing alcohol. As a result, the functional beer tends to be reduced in rich feeling or beer-like flavor.

Further, there are some beer-like drinks which are produced not through alcohol fermentation steps. These non-fermented beer-like drinks are poor in rich feeling and beer-like flavor. Therefore, the non-fermented beer-like drinks are also preferred as a target for improving taste quality. The non-fermented beer-like drink may be alcohol drink or non-alcohol drink.

In one embodiment, the beer-like drink which is a target for improving taste quality has an extract content of not more than 2.5% by weight, preferably not more than 1.5% by weight, more preferably not more than 0.64% by weight. The extract content means a concentration of non-volatile solids contained in a drink, the main components being carbon hydrates and proteins. By reducing content of the extract, carbohydrate is able to be reduced.

In one embodiment, the beer-like drink which is a target for improving taste quality has a content of carbohydrate of less than 0.5 g/100 ml. The carbohydrate means carbon hydrates which is different from dietary fiber. By reducing content of the carbohydrate, a bad influence on health caused by taking carbohydrate such as obesity and diabetes becomes hardly to occur.

In one embodiment, the beer-like drink which is a target for improving taste quality has a purine body content of not more than 1 mg/100 ml, preferably 0.5 mg/100 ml, more preferably 0.08 mg/100 ml. The purine body means the generic name for a compound having purine backbone. By reducing content of the purine body, a bad influence on health caused by taking purine body such as hyperuricemia and gout becomes hardly to occur.

In one embodiment, the beer-like drink which is a target for improving taste quality has an energy content of less than 5 kcal/100 ml. By reducing energy content, a bad influence on health caused by taking much energy becomes hardly to occur.

When the fatty acids having 8 to 14 carbon atoms is added to the beer-like drink which is a target for improving taste quality, the timing is not limited, and is able to be added at an appropriate step in the production steps of beer-like drink. When they are added to sparkling liquor, for example, the timing may be any step such as a cooling step after boiling wort, a fermentation step or a maturing step. It is however the timing after completion of the after-fermentation step is preferred because at the earlier step the addition step is conducted, the more the content of fatty acids having 8 to 14 carbon atoms would disappear. When they are added to the liquors, under the tax laws, addition have to be conducted before completion of the main fermentation, and it is preferred that they are added before starting the main fermentation or just before completion of the main fermentation. When they are added to the non-fermented drink, it is preferred that they are added after filtration.

The present invention will be described more specifically with reference to the following examples, but the present invention is not limited thereto.

### Example 1

### Addition of Fatty Acid Alone

55 ml/L of alcohol for raw materials, 1.5 g/L of acidulent, 0.1 g/L of hop extract, 0.1 g/L of amino acid, 0.011 g/L of Acesulfame K, 0.5 g/L of caramel pigment, 0.1 g/L of forming agent, 2 g/L of flavor and 19 g/L of indigestible dextrin were mixed in water so as to be the specified concentrations. Carbon dioxide gas was added to the mixture so as to be 0.230 MPa. Thereby, a non-fermented beer-like alcohol drink was produced.

The fatty acids having 8 to 14 carbon atoms were added alone to the non-fermented beer-like drink prepared in Example 1, and the concentration thereof were adjusted as shown in Tables 1 to 5. Five professional evaluators scored the resulting non-fermented beer-like alcohol drinks on a scale of 6 levels as to taste thickness and beer-like complex taste which contributes thereto. The evaluation standard is as follows. The evaluated score was average of the scored values by the five persons. The results were shown in Tables 1 to 5.

Evaluation standard

| Score | Effectiveness | Description |
|---|---|---|
| 0 | X | same level as that not added, no change |
| 1 | Δ-◯ | feel somewhat effect |
| 2 | ◯ | feel effect |
| 3 | ◯ | feel clear effect |
| 4 | ◯ | feel strong effect |
| 5 | ◯ | feel very strong effect |

TABLE 1
Added fatty acid: Octanoic acid

| Content | | Evaluated | |
|---|---|---|---|
| (ppm) | Effectiveness | score | Comment |
| 0 | — | 0 | watery |
| 0.5 | Δ | 1 | tingle, sting |
| 1.0 | ◯ | 2 | irritating bitterness |
| 2.0 | ◯ | 3 | thickness |
| 4.0 | ◯ | 4 | aftertaste prolonged echo, |
| | | | irritating |
| 10.0 | ◯ | 5 | sting, irritating, bitterness, |
| | | | thickness-richness, somewhat |
| | | | peculiar odor |
| 20.0 | ◯ | 5 | sting, irritating, bitterness, |
| | | | thickness-richness, somewhat |
| | | | peculiar odor |

TABLE 2
Added fatty acid: Decanoic acid

| Content | | Evaluated | |
|---|---|---|---|
| (ppm) | Effectiveness | score | Comment |
| 0 | — | 0 | watery |
| 0.05 | Δ | 1 | tingle, sting |
| 0.1 | ◯ | 2 | bitterness |
| 0.5 | ◯ | 3 | thickness |
| 1.0 | ◯ | 3 | thickness-richness, taste |
| | | | spreading |
| 5.0 | ◯ | 5 | thickness, peculiar odor |
| | | | (dusty, fatty) |
| 10.0 | ◯ | 5 | thickness, peculiar odor |
| | | | (dusty, fatty) |

TABLE 3
Added fatty acid: 9-Decenoic acid

| Content | Effective- | Evaluated | |
|---|---|---|---|
| (ppm) | ness | score | Comment |
| 0 | — | 0 | watery |
| 0.025 | Δ | 1 | tingle |
| 0.05 | ◯ | 1 | tingle, sting |
| 0.1 | ◯ | 2 | thickness |
| 0.3 | ◯ | 3 | thickness-richness |
| 1.0 | ◯ | 4 | aftertaste, echo |
| 5.0 | ◯ | 4 | thick aftertaste, echo |
| 10.0 | ◯ | 5 | strong richness, no peculiar |
| | | | odor |

TABLE 4
Added fatty acid: nonanoic acid

| Content | Effective- | Evaluated | |
|---|---|---|---|
| (ppm) | ness | score | Comment |
| 0 | — | 0 | watery |
| 0.05 | X | 1 | same level as that not added |
| 0.1 | Δ | 1 | tingle |
| 0.3 | ◯ | 2 | thickness |
| 0.6 | ◯ | 5 | bitterness, sweetness, very |
| | | | strong richness |
| 3.0 | ◯ | 5 | bitterness, sweetness, very |
| | | | strong richness |

TABLE 5
Added fatty acid: tetradecanoic acid

| Content | Effective- | Evaluated | |
|---|---|---|---|
| (ppm) | ness | score | Comment |
| 0 | — | 0 | watery |
| 0.05 | X | 0 | same level as that not added |
| 0.1 | Δ | 1 | tingle |
| 0.3 | ◯ | 2 | thickness |
| 0.6 | ◯ | 5 | bitterness, very strong |
| | | | richness |
| 3.0 | ◯ | 5 | bitterness, very strong |
| | | | richness |

The above results show that a suitable amount of the fatty acids having 8 to 14 carbon atoms which have been contained alone is able to enhance taste thickness and beer-like complex taste of a non-fermented beer-like alcohol drink.

### Example 2

### Addition of Plurality of Fatty Acids in Combination

A plurality of fatty acids having 8 to 14 carbon atoms were added in combination to the non-fermented beer-like drink produced in Example 1, and the concentration (ppm) thereof were adjusted as shown in Table 6.

TABLE 6

| Added fatty acid | Sample 1 | Sample 2 | Sample 3 | Sample 4 |
|---|---|---|---|---|
| Octanoic acid | — | 2.0 ppm | 2.0 ppm | |
| Decanoic acid | — | 0.2 ppm | 0.2 ppm | |
| 9-Decenoic acid | — | 0.1 ppm | | 0.1 ppm |
| Nonanoic acid | — | 0.1 ppm | | 0.1 ppm |
| Tetradecanoic acid | — | 0.1 ppm | | 0.1 ppm |

Five professional evaluators scored the resulting non-fermented beer-like alcohol drinks on a scale of 5 levels as to taste thickness and beer-like complex taste which contributes thereto. The evaluation standard is as follows. The evaluated score was average of the scored values by the five persons. The results were shown in Table 7.

Evaluation standard

| Score | Description |
|---|---|
| 1 | weak |
| 2 | somewhat weak |
| 3 | same as control |
| 4 | somewhat strong |
| 5 | strong |

TABLE 7

| Sample | Evaluated | |
|---|---|---|
| No. | score | Comment |
| 1 | 3 | watery, undependable, light |
| 2 | 5 | drink fulfillment, thickness, body, |
| | | irritating, acrid taste, after thickness, |
| | | stay behind, richness, sweetness |
| 3 | 3.8 | watery eased, somewhat body, irritating, |
| | | after thickness, somewhat richness, echo |
| 4 | 3.8 | thick aftertaste, more tasty than 3, |
| | | somewhat body, light, thick aftertaste, |
| | | completed |

The above results show that the plurality of fatty acids having 8 to 14 carbon atoms, which have been contained in combination, is able to enhance taste thickness and beer-like complex taste of a non-fermented beer-like alcohol drink.

### Examples 3 to 5

Addition of Plurality of Fatty Acids in combination

A commercially available beer-like non-alcohol drink (“DRY ZERO” (trade name) manufactured by Asahi Breweries, Ltd.) was prepared (Example 3).

A commercially available sparkling liquor having substantially no (zero) carbohydrate (“STYLE FREE” (trade name) manufactured by Asahi Breweries, Ltd.) was prepared (Example 4).

A commercially available beer-like alcohol drink having reduced (off) purine body (“ASAHI OFF” (trade name) manufactured by Asahi Breweries, Ltd.) was prepared (Example 5).

Beer-like drinks were produced according to the same manner as described in Example 2, except that DRY ZERO, STYLE FREE and ASAHI OFF were employed instead of the non-fermented beer-like alcohol drink shown in Example 1, and evaluation was conducted. The results were shown in Tables 8 to 10.

TABLE 8
Example 3 (Addition target: DRY ZERO)

| Sample | Evaluated | |
|---|---|---|
| No. | score | Comment |
| 1 | 3 | watery |
| 2 | 5 | thickness, irritating bitterness, |
| | | prolonged aftertaste, bitterness, |
| | | astringency |
| 3 | 4.5 | bitterness, thickness, irritating, |
| | | astringency |
| 4 | 4 | tingling sting, sharp |

TABLE 9
Example 4 (Addition target: STYLE FREE)

| Sample | Evaluated | |
|---|---|---|
| No. | score | Comment |
| 1 | 3 | sweet, watery, flat |
| 2 | 5 | massive bitterness, thickness, swelling |
| 3 | 4.5 | thick aftertaste, bitterness |
| 4 | 4 | tingling, tingling |

TABLE 10
Example 5 (Addition target: ASAHI OFF)

| Sample | Evaluated | |
|---|---|---|
| No. | score | Comment |
| 1 | 3 | watery, thin, flat |
| 2 | 5 | irritating, thickness, weight, richness |
| 3 | 4 | drink fulfilment, richness |
| 4 | 3.8 | tingling, light, sharp |

The above results show that the plurality of fatty acids having 8 to 14 carbon atoms, which have been contained in combination, is able to enhance taste thickness and beer-like complex taste of a beer-like non-alcohol drink and a fermented beer-like alcohol drink.

### Examples 6 to 8

Addition of Plurality of Fatty Acids in combination

A commercially available beer-like non-alcohol drink (“DRY ZERO” (trade name) manufactured by Asahi Breweries, Ltd.) was prepared (Example 6).

A commercially available sparkling liquor having substantially no (zero) carbohydrate (“STYLE FREE” (trade name) manufactured by Asahi Breweries, Ltd.) was prepared (Example 7).

A commercially available beer-like alcohol drink having reduced (off) purine body (“ASAHI OFF” (trade name) manufactured by Asahi Breweries, Ltd.) was prepared (Example 8).

A plurality of the fatty acids having 10 to 14 carbon atoms were added to the prepared beer-like drinks to adjust the concentrations (ppm) as shown in table 11.

TABLE 11

| Added fatty acid | Concentration (ppm) |
|---|---|
| Decanoic acid | 0.2 |
| 9-Decenoic acid | 0.1 |
| Tetradecanoic acid | 0.1 |

Three professional evaluators scored the resulting beer-like drinks on a scale of 5 levels as to taste thickness and beer-like complex taste which contributes thereto. The evaluation standard is the same as Example 2. The evaluated score was average of the scored values by the three persons. The results were shown in Tables 12 to 14.

TABLE 12
Example 6 (Addition target: DRY ZERO)

| Fatty | Evaluated | |
|---|---|---|
| acid | score | Comment |
| no | 3 | light, sour |
| addition | | |
| addition | 3.5 | sweetness, prolonged sweetness, echo, |
| | | thickness |

TABLE 13
Example 7 (Addition target: STYLE FREE)

| Fatty | Evaluated | |
|---|---|---|
| acid | score | Comment |
| no | 3 | watery, sour, quick sharpness |
| addition | | |
| addition | 4 | after sweetness, richness, echo, drink |
| | | fulfilment |

TABLE 14
Example 8 (Target of addition: ASAHI OFF)

| Fatty | Evaluated | |
|---|---|---|
| acid | score | Comment |
| no | 3 | sour, watery |
| addition | | |
| addition | 4.3 | tingling feeling, richness, echo, |
| | | thickness, bitterness |

The results of Examples 6 to 8 show that the plurality of fatty acids having 8 to 14 carbon atoms, which have been contained in combination, is able to enhance taste thickness and beer-like complex taste of a beer-like non-alcohol drink and a fermented beer-like alcohol drink.

### Comparative Example

### Addition of Isovaleric Acid

A commercially available sparkling liquor having substantially no (zero) carbohydrate (“STYLE FREE” (trade name) manufactured by Asahi Breweries, Ltd.) was prepared. Isovaleric acid ((CH₃)₂CHCH₂COOH) was added thereto to adjust the concentration as shown in Table 15. Five professional evaluators scored the resulting fermented beer-like alcohol drink on a scale of 5 levels as to taste thickness and beer-like complex taste which contributes thereto, flavor strength and unpleasant odor. The evaluation standard is as follows. The evaluated score was average of the scored values by the five persons. The results were shown in Table 15.

Evaluation standard

| Score | Description |
|---|---|
| 1 | weak |
| 2 | somewhat weak |
| 3 | same as control |
| 4 | somewhat strong |
| 5 | strong |

TABLE 15

| | | Strength score | | | |
|---|---|---|---|---|---|
| | | Taste | | | |
| | | thickness, | | | |
| | Content | complex | Flavor | Unpleasant | |
| No. | (ppm) | taste | strength | odor | Comment |
| 1 | 0 | 3 | 3 | 3 | |
| 2 | 0.005 | 3 | 3 | 3 | no difference |
| | | | | | from control |
| 3 | 0.010 | 3 | 3.5 | 3 | gorgeous hop |
| 4 | 0.020 | 3 | 3.5 | 3.5 | alcoholic |
| 5 | 0.040 | 3 | 3.5 | 4 | yoghurt flavor |
| 6 | 0.080 | 3 | 3.5 | 4.5 | yoghurt flavor, |
| | | | | | musty smell |

The above results show the followings.

By addition of isovaleric acid, change in taste thickness and beer-like complex taste was not realized.

By addition of isovaleric acid, increase in flavor strength of the drink was realized.

On the other hand, it was realized the trend that unpleasant flavor of isovaleric acid is added as the addition amount increases.

1. A beer-like drink obtained by including a fatty acid having 8 to 14 carbon atoms.

2. The beer-like drink according to claim 1, wherein the fatty acid having 8 to 14 carbon atoms comprises at least one selected from the group consisting of octanoic acid, decanoic acid, 9-decenoic acid, nonanoic acid and tetradecanoic acid.

3. The beer-like drink according to claim 1, wherein kind and concentration of the fatty acid included in the beer-like drink is at least one selected from the group consisting of the following i) to v):
i) 0.2 to 20 ppm of octanoic acid;
ii) 0.02 to 20 ppm of decanoic acid;
iii) 0.01 to 20 ppm of 9-decenoic acid;
iv) 0.05 to 5 ppm of nonanoic acid; and
v) 0.05 to 5 ppm of tetradecanoic acid.

4. A beer-like drink obtained by including a fatty acid having 10 to 14 carbon atoms.

5. The beer-like drink according to claim 4, wherein kind and concentration of the fatty acid included in the beer-like drink is at least one selected from the group consisting of the following i) to iii):
i) 0.02 to 20 ppm of decanoic acid;
ii) 0.01 to 20 ppm of 9-decenoic acid; and
iii) 0.05 to 5 ppm of tetradecanoic acid.

6. The beer-like drink according to claim 1, which is a non-fermented beer-like drink.

7. The beer-like drink according to claim 1, having an extract content of not more than 2.5% by weight.

8. The beer-like drink according to claim 1, having a carbohydrate concentration of less than 0.5 g/100 ml.

9. The beer-like drink according to claim 1, having a purine body concentration of not more than 1 mg/100 ml.

10. The beer-like drink according to claim 1, having an energy amount of less than 5 kcal/100 ml.

11. A process for producing a beer-like drink comprising a step of including a fatty acid having 8 to 14 carbon atoms.
